(19) United States
(12) Patent Application Publication
(10) Pub. No.: US 2015/0081392 A1
(43) Pub. Date: Mar. 19, 2015

(54) COMPETITOR PREDICTION TOOL

(71) Applicant: Knowledge Support Systems Ltd., Manchester (GB)

(72) Inventors: David Fox, Salford (GB); Xiaojun Zeng, Cheshire (GB)

(21) Appl. No.: 14/029,432

(22) Filed: Sep. 17, 2013

(51) Int. Cl. G06Q 30/02

(52) U.S. Cl. CPC G06Q 30/0206
USPC 705/7.35

(57) ABSTRACT

A method of generating fuel price data for a retail fuel site. The method comprises receiving relationship data indicating a relationship between the retail fuel site and a competitor retail fuel site and receiving fuel price data for the competitor retail fuel site. The fuel price data for the competitor retail fuel site is processed to generate estimated fuel price data for the competitor retail fuel site and the fuel price data for the retail fuel site is generated based upon the relationship data and the estimated fuel price data.

### TECHNICAL FIELD

The present invention relates to methods and systems for price optimisation.

### BACKGROUND OF THE INVENTION

In many industries, commercial organisations have to determine prices at which their products are to be sold. Determination of such prices will need to take into account various factors. For example, a particular commercial organisation may wish to ensure that its prices are within a predetermined limit of a particular competitor's prices. Similarly, a commercial organisation may wish to ensure that a particular constraint is applied such that prices of different products sold by that organisation have a predetermined relationship with one another.

A particular industry in which prices need to be determined is the fuel industry. In particular, it is necessary to determine prices at which fuel is to be sold at retail fuel sites. The price charged by a particular retail fuel site will be determined by a number of different parameters. For example, prices charged by the retail fuel site's competitors are likely to need to be taken into account, as are prices of various other products sold by the retail fuel site. Typically, a plurality of retail fuel sites operate in a particular region, and prices charged by different retail fuel sites in a particular region will routinely need to be taken into account. Additionally, prices charged in different regions in associated retail fuel sites may also need to be taken into account.

Traditionally, prices at which retail fuel sites sell fuel have been determined by skilled analysts who have mentally collated and processed data representing various parameters which need to be taken into account. Having carried out this processing, analysts can typically determine pricing, often convening at a meeting at which a plurality of pricing analysts make various strategy decisions.

More recently, automated systems for determining retail fuel prices have been used. In these automated systems data required for determining pricing is collected and provided to a pricing system which is often located remotely from the retail site. The pricing system uses the provided data together with other information to determine information useful for optimising fuel prices at the retail site. The other information may include a desired pricing strategy such as pricing that optimises sales volumes or that optimises retail site profit. The information generated by the pricing system generally takes the form of recommended pricing for fuels that satisfies the desired pricing strategy, but may also include other useful information such as reports and predictions of competitor prices.

There remains a need for improvements in pricing systems and methods.

### SUMMARY OF THE INVENTION

According to a first aspect of the invention there is provided a method of generating fuel price data for a retail fuel site, the method comprising: receiving, as input to the processor, relationship data indicating a relationship between the retail fuel site and a competitor retail fuel site; receiving, as input to the processor, fuel price data for the competitor retail fuel site; processing, by the processor the fuel price data for the competitor retail fuel site to generate estimated fuel price data for the competitor retail fuel site; and generating, by the processor, said fuel price data for the retail fuel site based upon the relationship data and the estimated fuel price data.

Fuel price data is typically generated for a retail fuel site using upon observed competitor prices, which may for example be obtained from a competitor retail fuel site by pricing surveys of the competitor retail fuel site at predetermined times during a day. However competitor prices often change during a day and between pricing surveys. By generating fuel price data for a retail fuel site based upon estimated fuel price data, rather than only using observed competitor prices, it is possible to estimate competitor fuel pricing between observations of the competitor prices and thereby to improve pricing during the day.

The estimated fuel price data for the competitor retail fuel site may be a prediction of fuel price for the competitor retail fuel site at a time in the future. That is, fuel price data may be estimated for the competitor retail fuel site at future times. Alternatively the estimated fuel price data for the competitor retail fuel site may be an estimate of historical fuel price for the competitor retail fuel site that is unavailable, for example where a pricing survey was not carried out the invention allows an estimate of the fuel price data for the competitor retail fuel site to be generated.

The fuel price data for the competitor retail fuel site may comprise a value for each of a plurality of variables associated with the competitor retail fuel site. The plurality of variables associated with the competitor retail fuel site may comprise at least one value selected from the group consisting of: a value indicating a current weekday; a value indicating a time for which a prediction is to be made; a value indicating a current cost difference between a fuel price at the competitor retail fuel site at first and second times; a value indicating a difference between fuel price at the retail fuel site at a first time and fuel price at the competitor retail fuel site at a second time; a value indicating a change in fuel price at the retail fuel site since a previous a change in fuel price at the competitor retail fuel site; and a time since a most recent competitor price change.

Processing the fuel price data for the competitor retail fuel site to generate estimated fuel price data for the competitor retail fuel site may comprise: receiving, as input to the processor, a model; and processing, by the processor, the fuel price data for the competitor retail fuel site based upon the received model. The model may for example be a support vector regression model. Support vector regression modelling techniques have been found to provide good estimates of competitor fuel price data based upon historical fuel price data.

The method may further comprise generating the model. The model may be generated by: receiving a training set of data, the training set of data providing fuel price data for the competitor retail fuel site at a plurality of times; and processing, by the processor, the training set of data using a quadratic programming method to determine at least one Lagrangian multiplier. For example two Lagrangian multipliers may be generated based upon historical data that allow estimates of fuel price data to be generated at future times.

The training set of data may comprise an observed price for the competitor retail fuel site at each of the plurality of times, and processing the training set of data to determine at least one Lagrangian multiplier may comprise, for each of the plurality of times: determining an estimated price for the competitor site for said plurality of times; determining, by the processor, whether a difference between the estimated price and the observed price exceeds a predetermined value; and if the difference exceeds a predetermined value, assigning a penalty to said data for said time.

The model may comprise an average value. The average value may be generated based upon a training set of data providing fuel price data for the competitor retail fuel site at a plurality of times.

The method may further comprise: receiving at least one bound associated with the competitor retail fuel site; and generating said estimated fuel price data for the competitor retail fuel site based upon the at least one bound.

The at least one bound may be associated with a maximum change of fuel price data at the competitor retail fuel site. For example, the at least one bound may be associated with a maximum positive change and/or a maximum negative change of a fuel price at the competitor retail fuel site in a predetermined time period. The at least one bound may for example be determined by processing a training set of data associated with fuel price data changes at the competitor retail fuel site. The estimated fuel price data may be generated by determining whether a difference between the estimated fuel price data for the competitor retail fuel site and the fuel price data for the competitor retail fuel site exceeds the bound. If the difference exceeds the bound the estimated fuel price data may be modified, for example based upon the bound.

The support vector regression provides a black box processing method. Accordingly, it is desirable to provide bounds on predictions of change generated by the method.

According to a second aspect of the invention there is provided a method of generating data associated with fuel sales at a retail fuel site, the method comprising: receiving fuel price data for the retail fuel site; receiving fuel price data for at least one competitor retail fuel site; receiving a model, the model being based upon a relationship between fuel sales and store sales at said retail fuel site and being arranged to generate a profit based upon values of a plurality of parameters; processing the model and the fuel price data for the retail fuel site and the fuel price data for the at least one competitor retail fuel site to generate said data associated with fuel sales at the retail fuel site; and updating the plurality of parameters based upon the processing.

By updating parameters based upon processing to generate data associated with fuel sales at a retail fuel site in this way, the inventor has realised that improved data associated with fuel sales can be generated.

Updating the plurality of parameters based upon the processing may comprise: determining a forecast error based upon the data associated with fuel sales at the retail fuel site; and updating the plurality of parameters based upon the forecast error. That is, the parameters of the model may be updated based upon a difference between a forecast of fuel sales in a predetermined time period generated using the model and actual fuel sales in the time period, for example received at the end of the time period.

Updating the plurality of parameters based upon the forecast error may comprise: receiving volatility data associated with variability of the fuel price data for the retail fuel site and the fuel price data for the at least one competitor retail fuel site; and updating the plurality of parameters based upon the forecast error and the volatility data. The volatility data may for example indicate the volatility of the parameters of the model during a predetermined time period. By updating the parameters of the model taking into account the volatility of the parameters of the model during a predetermined time period in this way the parameters of the model are resilient to outlier data for a particular time period.

Updating the plurality of parameters based upon the processing may comprise: generating an initial value associated with each of said plurality of parameters based upon the processing; receiving a plurality of bounds associated with said plurality of parameters; and processing said initial values of said plurality of parameters based upon said plurality of bounds to update the plurality of parameters. The plurality of bounds may for example provide threshold values for the parameters. Given the nature of fuel pricing parameters, updating of parameters at regular intervals, compared to initialisation of a model and subsequent use of the initialised model to generate fuel sales data, may be problematic. However by using bounds on updated values of the plurality of parameters the parameters can be updated during use of the model based upon actual data that is received.

Processing said initial values of said plurality of parameters based upon said plurality of bounds to update the plurality of parameters may comprise, for each of said plurality of parameters: determining whether said initial value associated with said parameter is within said plurality of bounds; and if said initial value associated with said parameter is not within said plurality of bounds: updating said parameter based upon a modified value of said initial value.

If said initial value associated with said parameter is not within said plurality of bounds, updating at least one further parameter of said plurality of parameters based upon said modified value of said initial value of said parameter. The modification of a further parameter in this way allows the update of the model parameters to take into account all variation without an updated value for a parameter being outside of a predetermined threshold. Given the nature of fuel pricing parameters, such shifting of values from one parameter of the model to a different parameter of the model allows the model to be updated during processing of actual data such that the model parameters continuously adjust to the most recently received data.

At least one of said plurality of parameters may be associated with an own price elasticity, wherein at least one of said plurality of bounds limits said own price elasticity to a negative value.

At least one of said plurality of parameters is associated with a competitor price elasticity, wherein at least one of said plurality of bounds limits said competitor price elasticity to a positive value.

The model may comprise an observation equation specifying a relationship between the plurality of parameters. The model may comprise a state equation for each of the plurality of parameters, the state equation for each parameter specifying a relationship between the value of the parameter at a first time and the value of the parameter at a second time. The relationship between the value of the parameter at a first time and the value of the parameter at a second time is associated with a normally distributed error term. The model may be a dynamic linear model.

According to a further aspect of the invention there is provided a method of generating fuel price data for a retail fuel site, the method comprising: receiving relationship data indicating a relationship between the retail fuel site and a competitor retail fuel site; receiving fuel price data for the competitor retail fuel site; generating a first plurality of fuel prices for the retail fuel site at a first time based upon the relationship data and the fuel price data for the competitor retail fuel site; generating a second plurality of fuel prices for the retail fuel site at a second time, each of the second plurality of fuel prices being associated with one of the first plurality of fuel prices; and generating the fuel price data for the retail fuel site based upon the second plurality of fuel prices and associated first plurality of fuel prices.

By generating fuel price data for a retail fuel site based upon a second plurality of fuel prices associated with a second time and an associated first plurality of fuel prices associated with a first time the invention allows fuel price data to be generated that takes into consideration future consequences of fuel pricing decisions. In contrast to prior art fuel pricing methods therefore the present invention provides a way in which fuel pricing to be optimised across a whole time period, rather than performing independent optimisation at each time point in the time period.

Generating the fuel price data for the retail fuel site based upon the second plurality of fuel prices and associated first plurality of fuel prices may comprise: generating a plurality of profit values, each of said plurality of profit values being associated with a respective one of said second plurality of fuel prices and associated one of said first plurality of fuel prices; determining a maximum profit value of said plurality of profit values; and generating said fuel price data for the retail fuel site based upon the second plurality of fuel prices and associated one of said first plurality of fuel prices associated with the determined maximum profit value. The optimisation may therefore calculate a total profit across a time period for each of a plurality of possible pricing combinations at times in the time period and the combination that provides the optimal profit may be selected, possibly taking into account other pricing constraints such as a required volume fuel sales. The profit for each pricing combination may for example be determined using the second aspect of the invention.

Generating the fuel price data for the retail fuel site based upon the second plurality of fuel prices and associated first plurality of fuel prices may comprise selecting one of the second plurality of fuel prices and associated first plurality of fuel prices.

The received fuel price data for the competitor retail fuel site may comprise an estimated fuel price for the competitor retail fuel site at the first time. The estimated fuel price for the competitor retail fuel site may for example be generated according to the first aspect of the invention.

The relationship data may indicate constraints for the fuel price for the retail fuel site relative to a price at the competitor retail fuel site. Generating the first plurality of fuel prices for the retail fuel site may comprise generating each possible fuel price for the retail fuel site based upon the constraints. For example, the constraints may provide a maximum and minimum price for the retail fuel site and the first plurality of fuel prices may comprise each possible fuel price between the maximum and minimum prices.

The second plurality of fuel prices may be generated based upon the relationship data and fuel price data for the competitor retail fuel site.

The method may further comprise: generating a plurality of fuel prices for the competitor retail fuel site, each of the generated plurality of fuel prices being based upon a respective one of the first plurality of fuel prices for the retail fuel site. For example the plurality of fuel prices for the competitor retail fuel site may be generated based upon the first aspect of the invention. Generating a second plurality of fuel prices for the retail fuel site at a second time may comprise, for each of the generated plurality of fuel prices for the competitor retail fuel site, generating a plurality of fuel prices for the retail fuel site at the second time based upon the relationship data and the generated fuel price for the competitor retail fuel site. For example the plurality of fuel prices for the retail fuel site may be generated in the same way as the first plurality of fuel prices described above.

It will be appreciated that the invention can be implemented in any convenient way. For example, aspects of the invention provide not only methods but also suitably configured apparatus. The invention may be carried out by means of suitable computer programs which may be carried out on appropriate carrier media. Such media includes both tangible carrier media and intangible carrier media. When the methods described above are implemented using a computer the various images and models may be represented by way of digital data which is stored in a suitable memory in the computer.

### BRIEF DESCRIPTION OF THE DRAWINGS

Embodiments of the invention will now be described with reference to the accompanying drawings in which:

FIG. 1 is a schematic illustration of a part of a network of associated retail fuel sites in communication with a pricing system;

FIG. 2 is a schematic illustration of the pricing system of FIG. 1;

FIG. 2A is a schematic functional block diagram of part of the pricing system of FIG. 1;

FIG. 3 is a schematic illustration showing a computer associated with the pricing system of FIG. 2 in further detail;

FIG. 4 is a flowchart showing processing carried out to generate fuel sales data in accordance with an embodiment of the invention;

FIG. 5 is a flowchart showing processing carried out to train a model suitable for use in the processing of FIG. 4;

FIG. 6 is a flowchart showing processing to update parameters of the model of that is trained using the processing of FIG. 5;

FIG. 7 is a flowchart showing processing to generate price predictions for a fuel site in accordance with an embodiment of the invention;

FIG. 8 is a flowchart showing processing to generate price data in accordance with an embodiment of the invention;

FIG. 9 is a flowchart showing part of the processing of FIG. 8 in further detail; and

FIG. 10 is a flowchart showing processing to price taking into account future competitor price changes.

### DETAILED DESCRIPTION

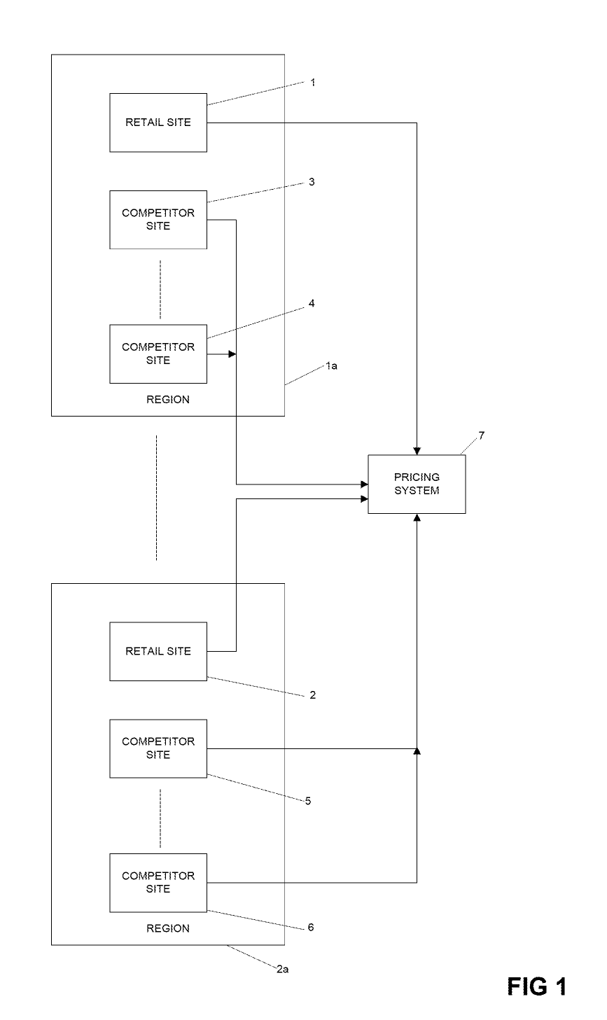

Referring first to FIG. 1 part of a network of associated retail fuel sites, 1, 2 is illustrated. Each of the associated retail fuel sites may be, for example, owned or operated by a single commercial entity, or may be supplied by a particular fuel supplier. Each of the associated retail fuel sites 1, 2 has an associated region 1a, 2a which defines a geographical area in which competitor retail sites 3, 4, 5, 6 are considered to be direct competitors. That is, competitor sites 3, 4 which lie in region 1a are direct competitors of the first associated retail site 1 and competitor sites 5, 6 which lie in region 2a are direct competitors of the second associated retail site 2 such that sales of sites lying in region 1a affect sales of other sites lying in region 1a and sales of sites lying in region 2a affect sales of other sites lying in region 2a. It will be appreciated that a wider area such as a country will generally be divided into a plurality of regions in which retail sites compete with competitor sites. Regions may be selected based upon a geographical region such as an area surrounding a city or may be selected based upon other factors that determine competing sites such as sites located along a particular highway.

Associated retail fuel sites 1, 2 in the network of associated retail fuel sites may further be arranged in networks indicating groups of associated retail fuel sites that share a common pricing strategy such as retail fuel sites located at motorway service stations or retail fuel sites located in urban or rural areas. Additionally, associated retail fuel sites may be operated under various contract types and retail fuel sites operating under particular contract types may also be arranged into networks. Examples of contract types under which retail fuel sites may operate may include “company owned, company operated”, “company owned, franchisee operated”, “dealer owned, dealer operated” and “company owned, dealer operated”. The associated retail fuel sites and competitor retail fuel sites, networks and regions are used to construct a model defining interrelationships between associated retail fuel sites and competitor retail fuel sites. Where changes to the networks and regions subsequently occur, the model defining interrelationships between the sites is updated to reflect the changes.

A pricing system 7 is arranged to receive various data including data associated with each of the associated retail sites 1, 2 and data associated with competitor sites 3, 4, 5, 6. The pricing system 7 is arranged to process the received data and to generate various output data, in particular an optimal pricing strategy for each of the products at each of the associated retail sites 1, 2 based upon the provided information.

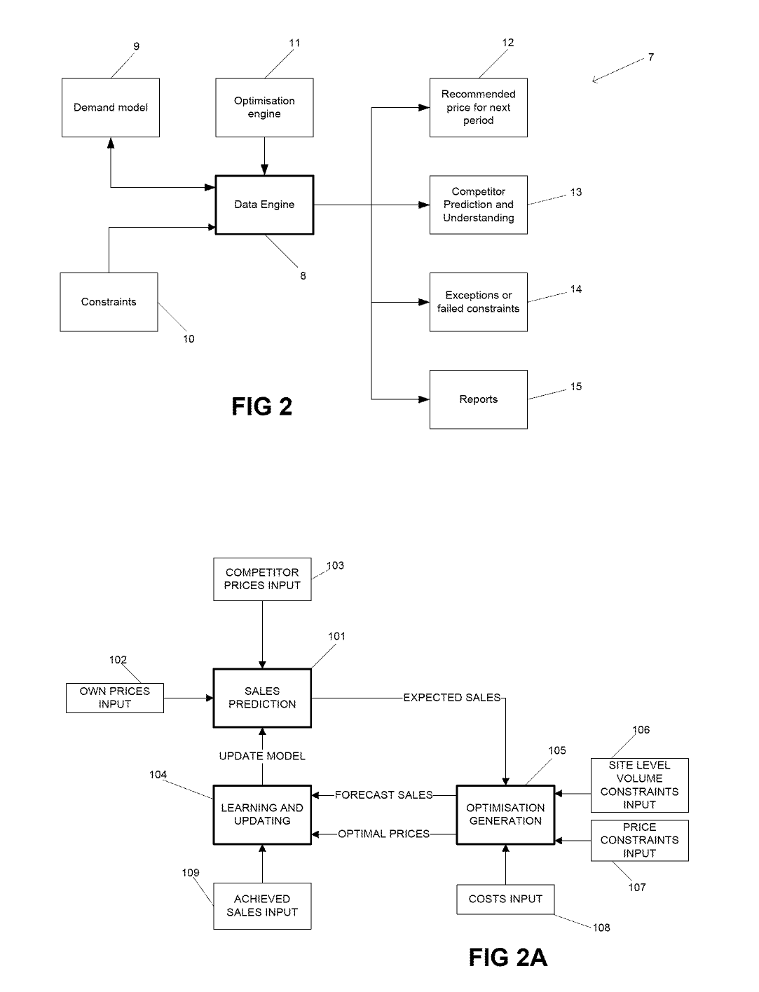

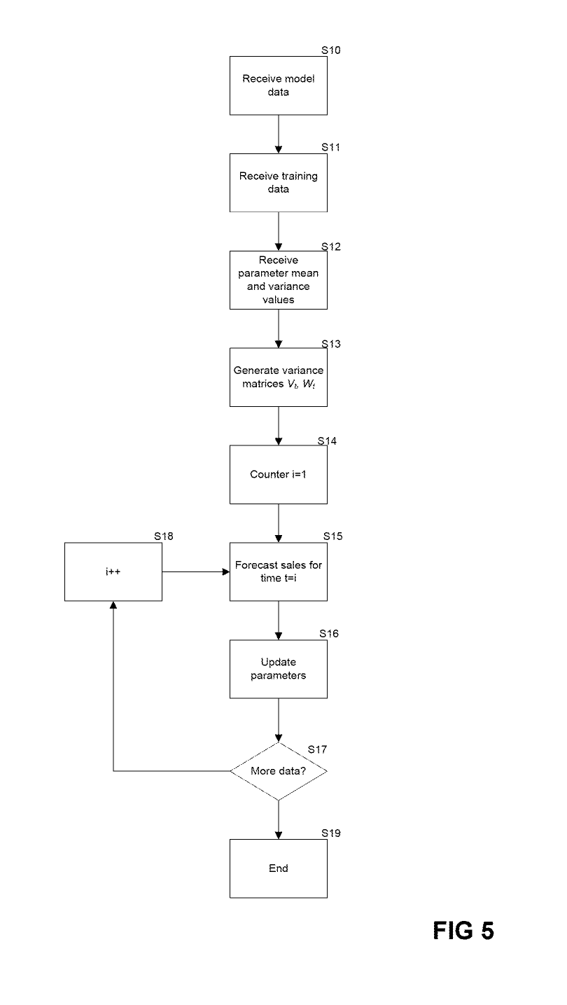

FIG. 2 shows operation of the pricing system 7 of FIG. 1 in more detail. It can be seen that the pricing system 7 takes various data as input, and generates various data as output as described above. Specifically, a data engine 8 takes as input a demand model 9 and constraints 10 and uses an optimisation engine 11. The demand model 9 forecasts sales volume for each product by site and time period. The demand model 9 uses past sales history at each site together with site prices and competitor site prices as well as elasticity values indicating sensitivity of customers to price changes for each product at each associated retail site 1, 2 and time period possibly together with other factors such as factors associated with the day of the week. The elasticity values provide an estimate of how demand for a particular product is likely to vary in response to price changes, either by an associated retail site 1, 2 or a competitor site 3, 4, 5, 6, and may be determined in an offline process for example using linear or non-linear regression modelling techniques based upon historic sales and price data, for example using stepwise or ridge regression, or using dynamic linear modelling as described in further detail below with reference to FIGS. 4 and 5.

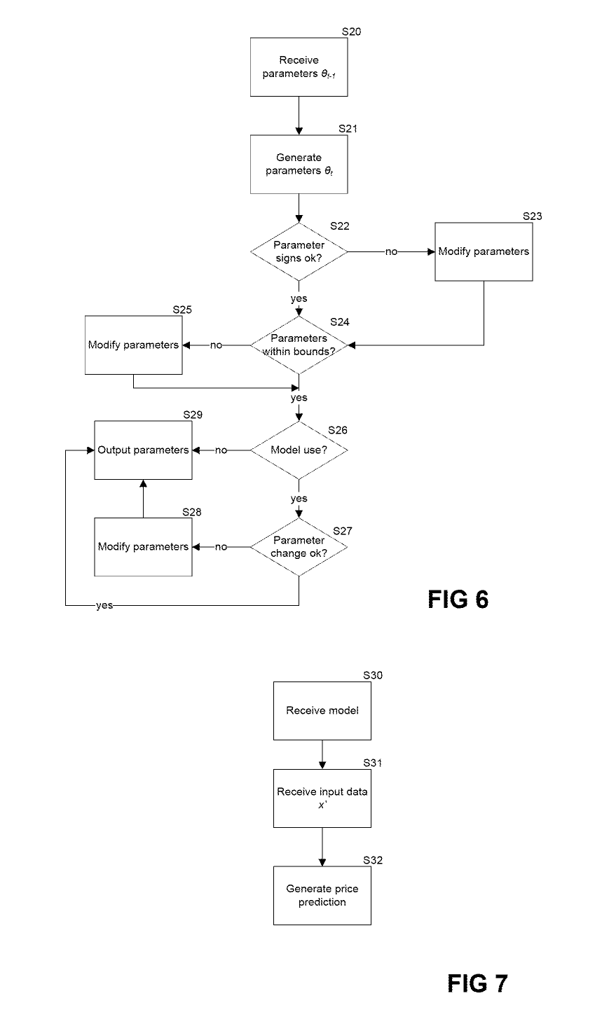

The retail site data and competitor site data may be provided to the pricing system 7 using a data link which automatically provides retail site data to the pricing system 7, for example at the end of each day. Competitor data is collected by the associated retail sites 1, 2 and provided to the pricing system 7 in any convenient way, for example by using the same data link as used to provide retail site data or alternatively using mobile computing devices which are used by operatives to collect the competitor data from the competitor site and which provide the competitor data to the pricing system 7 over wireless telecommunications. Alternatively, data may be provided in any convenient way. In some embodiments, however some competitor data may not be available and competitor data may be estimated as described below with reference to FIG. 6.

The constraints 10 allow a user to specify rules defining pricing strategies by site and/or product. The rules take the form of price differentials and ranges which it is desirable are satisfied by prices at an associated retail site 1, 2. Price differentials determine a pricing position of a site relative to other competitor sites within a region. Price differentials are used to indicate a range of acceptable prices for a particular product relative to corresponding competitor prices and the data engine 8 seeks to determine product prices which satisfy the specified price differentials. Price differentials may provide different ranges of acceptable prices relative to different competitors and in particular may include a differential relative to a main competitor and additionally or alternatively may include a differential relative to a different site in the network of associated retail fuel sites 1, 2, such that pricing at a first site in the network generally follows pricing at a second site in the network.

Price differentials may either be constraint-type differentials indicating constraints on prices that should be satisfied, often relative to a main competitor for a particular site, or guide-type differentials, which are optional constraints that are to be satisfied where possible, but which may be ignored if they cannot be met. Where a guide-type differential is not satisfied by pricing determined for a particular site, the site may be added to a list of sites to be manually reviewed, for example by an expert analyst or a manager at an associated retail fuel site 1, 2. Alternatively, rules may be relaxed either manually or automatically such that optimal prices can be determined. That is, where it is determined that all of the currently specified rules cannot be satisfied, one or more of the rules may be made less restrictive. The one or more rules may be selected based upon an order which specifies the order in which rules should be relaxed if all of the rules cannot be satisfied.

The optimisation engine 11 is used to determine a set of prices which maximise some objective, whilst attempting to satisfy the rules specified by the constraints 10. In general terms, price optimisation is concerned with balancing profit with volume sales within specified price constraints. The optimisation engine takes as input a policy which indicates the relative importance of profit and volume sales for the optimisation and may be provided as a value between 0 and 100 where 0 indicates that profit is to be maximised and 100 indicates that volume is to be maximised, and values between 0 and 100 indicate relative proportions of profit and volume maximisation. The optimisation engine 11 may additionally be provided with data indicating information about the current market environment which can be taken into account in the generation of prices such as, for example data indicating expected variation in sales in a region or network. Examples of additional information may include data indicating that an event caused a reduction of sales on a particular day, or that a forthcoming event is likely to cause high sales such that strategy should be modified, for example to maximise profit.

The data engine 8 uses the demand model 9, constraints 10 and optimisation engine 11 to generate a recommended price 12 for each product at each associated retail fuel site 1, 2 in the network of associated retail fuel sites using modelling techniques well known in the art. For example, sequential quadratic programming, active set solvers, interior point solvers or other suitable non-linear optimisation techniques may be used to generate the recommended price 12. Additionally, a daily error-correction process such as a Kalman filter or dynamic linear model may be used to update model parameters in light of prediction errors. In some embodiments the data engine 8 may use game theory to generate a recommended price 12 as described in detail below with reference to FIG. 7.

The data engine 8 may additionally provide output data 13 which can be used to predict competitor price changes, and to understand competitor pricing policies. Competitor price change prediction is described in detail below with reference to FIG. 6. Data 14 is generated indicating constraints which are specified by the constraints 10 but which are not satisfied by the recommended price 12. Reports 15 may also be generated by the data engine 8. The output data may be provided to the associated retail site 1, 2 in any convenient way, for example using the same method as that used to provide retail site and competitor data to the pricing system 7 from the retail site.

Referring now to FIG. 2A, a schematic functional block diagram of the pricing system is shown. The system has three functional blocks 101, 104, 105 which each take data as input, from external sources and/or from others of the three functional blocks, and each generate output data.

In more detail, a sales prediction block 101 takes as input own prices 102 and competitor prices 103 together with an updated model generated at a learning and updating block 104, and outputs expected sales for the current period. The expected sales output from the sales prediction block 101 are input to an optimisation generation block 105 which also takes as input site level volume constraints 106 (indicating minimum required volume sales for a site), price constraints 107 and costs 108. The optimisation generation block processes its inputs and generates a set of optimal prices and a corresponding forecast of sales, the forecast of sales being based upon the generated set of optimal prices. The forecast of sales and the optimal prices output from the optimisation generation block 105 are input to the learning and updating block 104, together with achieved sales during the period for which the optimal prices were generated and used. The updated model that is passed to the sales prediction block 101 is generated at the learning and updating block 104 based upon the forecast sales for the period and the achieved sales for the period. In this way, the sales prediction for the next period is improved.

The optimal prices for an associated retail fuel site i, generated at the optimisation generation block 105 of FIG. 2A, can be determined by solving an optimisation problem of the form shown in equation (1):

$$maximise {\sum }_{i = 1}^{m} {\sum }_{k = 1}^{p} {G}_{tik} \\ with respect to own prices \text{:} {\{ {P}_{tik} \}}_{i = 1 … m , k = 1 … p} ; \\ subject to price constraints \text{:} {\{ {g}_{{l}_{ik}} \geq 0 \}}_{{l}_{ik} = 1 … {q}_{ik} , i = 1 … m , k = 1 … p} ; \\ and \\ site level volume constraints \text{:} {\{ {\sum }_{k} {V}_{tik} \geq {L}_{ti} \}}_{i = 1 … m} \qquad ( 1 )$$

where:
i is an index indicating an ith one of m associated retail fuel sites;
j is an index indicating a jth one of n competitor sites;
k is an index indicating a kth one of p fuel products;
t is a time period;
Gₜᵢₖ indicates gross profit from sale of grade k at site i in time period t and can be modelled in the form shown below in equation (3);
Pₜᵢₖ indicates the current price of fuel product k at associated retail fuel site i and time t;
lᵢₖ is an index indicating an lᵢₖth one of qᵢₖ price constraints indicating constraints on price such as a constraint on price difference between own and competitor products for a particular fuel product k;
gₗ_{ᵢₖ} models the qᵢₖ price constraints as a linear function of own price, cost and competing prices for site i and fuel product k and has the form shown in equation (4) below;
Vₜᵢₖ indicates sales volume in time period t at site i for grade k and can be modelled in the form shown below in equation (2); and
Lₜₗ indicates a minimum volume target for sales in time period t at site i.

Sales volume is modelled by a demand model, which has the general form shown in equation (2):

Vₜᵢₖ=f(Vₛᵢₖ,Pₜᵢₖ,Pₜⱼₖ) (2)

where:
Vₛᵢₖ indicates previous sales at a time s<t;
Pₜⱼₖ indicates the current price of fuel product k at competitor retail fuel site j and time t; and
f is a model describing the relationships (referred to as elasticities) between own prices and competitor prices, based upon previous sales Vₛᵢₖ and generally is a log-log or log-linear model. The coefficients of the price terms off are price elasticities. Further details of the form and estimation of the model can be found in, for example the following, which are herein incorporated by reference: Singh, M. G., Bennavail, J.-C, (1993) “Experiments in the use of a knowledge support system for the pricing of gasoline products”, Information & Decision Technologies 18(6): 427-442; Krasteva, E., Singh, M. G., Sotirov, G., Bennavail, J.-C., and Mincoff, N., (1994) “Model Building for pricing decision making in an uncertain environment, Proc. IEEE International Conference on Systems, Man and Cybernetics”, San Antonio; and Bitran, G., Caldentey, R. and Mondeschein, S. (1998) “Coordinating clearance markdown sales of seasonal products in retail chains”, Operations Research 46(5): 609-624.

Accordingly gross profit Gₜᵢₖ can be modelled as shown in equation (3):

$${G}_{tik} = ( \frac{{P}_{tik}}{1 + v} - {C}_{tik} ) {V}_{tik} = ( \frac{{P}_{tik}}{1 + v} - {C}_{tik} ) f ( {V}_{sik} , {P}_{tik} , {P}_{tjk} ) \qquad ( 3 )$$

where:
Pₜᵢₖ indicates current price of fuel product k at site i and time t as above;
Cₜᵢₖ indicates direct sales costs for fuel product k in time period t at site i; and
v is the applicable sales tax rate.

The price constraints gₗ_{ᵢₖ} can be modelled in the form shown in equation (4):

gₗ_{ᵢₖ}(Pₜᵢₖ,Cₜᵢₖ,Pₜⱼₖ) (4)

where Pₜᵢₖ, Cₜᵢₖ and Pₜⱼₖ are as described above.

The optimisation problem of equation (1) can be solved using non-linear optimisation techniques well known in the art such as those described in Gill, P. E., Murray, W., and Wright, M. H., “Practical Optimisation” (1981), Academic Press, which is herein incorporated by reference. Alternatively the optimisation problem of equation (1) can be solved using dynamic linear modelling as described below with reference to FIG. 4 and/or taking into account future effects of pricing as described below with reference to FIG. 7. The optimisation provides a set of prices Pₜᵢₖ, indicating an optimal price at each site for each fuel product given various constraints that are applicable at the current time t.

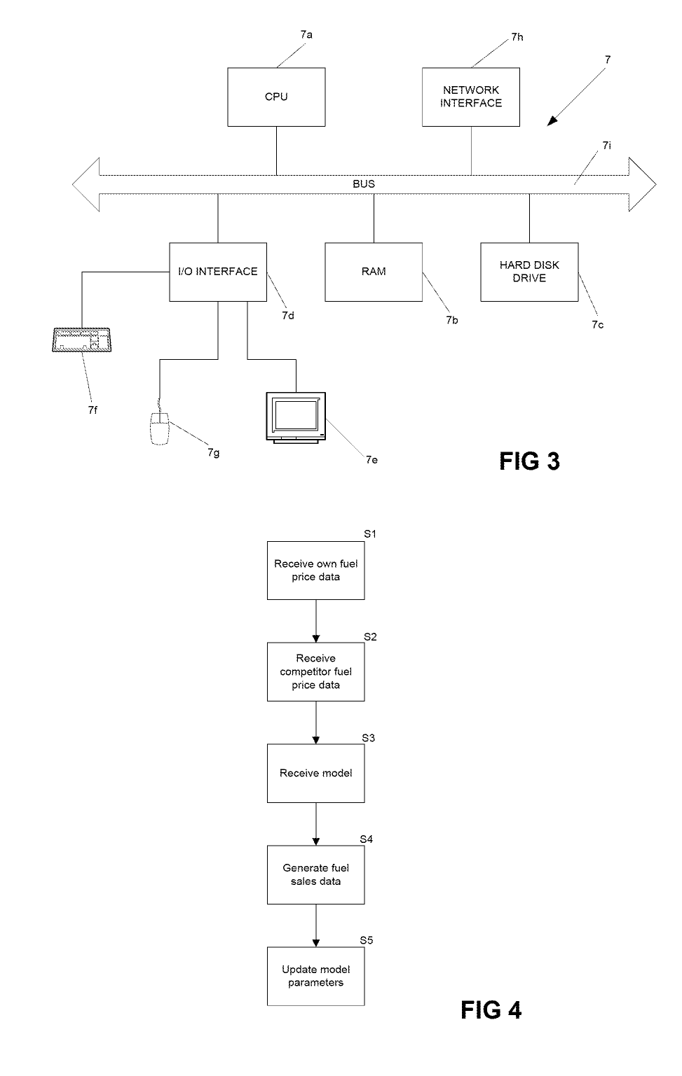

FIG. 3 shows a computer associated with the pricing system 7 of the system of FIG. 1 in further detail. It can be seen that the computer associated with the pricing system comprises a CPU 7a which is configured to read and execute instructions stored in a volatile memory 7b which takes the form of a random access memory. The volatile memory 7b stores instructions for execution by the CPU 7a and data used by those instructions. For example, in use, software used to determine optimal prices for retail fuel sites may be stored in volatile memory 7b.

The computer associated with the pricing system 7 further comprises non-volatile storage in the form of a hard disc drive 7c. Data such as retail fuel site data and competitor site data may be stored in the hard disc drive 7c. The computer associated with the pricing system 7 further comprises an I/O interface 7d to which are connected peripheral devices used in connection with the computer associated with the pricing system 7. The computer associated with the pricing system 7 has a display 7e configured so as to display output from the data engine. Input devices are also connected to the I/O interface 7d. Such input devices include a keyboard 7f, and a mouse 7g which allow user interaction with the data engine. A network interface 7h allows the computer associated with the pricing system 7 to be connected to an appropriate computer network so as to receive and transmit data from and to other computing devices such as computing devices provided at the retail fuel sites. The CPU 7a, volatile memory 7b, hard disc drive 7c, I/O interface 7d, and network interface 7h, are connected together by a bus 7i.

As described above, sales volume is modelled by a demand model, which has the general form shown in equation (2). The demand model uses previous price and sales data for retail fuel sites associated with a site to forecast sales at the site. In one embodiment the demand model has the form shown in (5):

Sₜ=β_{1,t}*(Pₜ)^{β}^{_{2,t}}*(CP_{1,t})^{β}^{_{3,t}}* . . . *(CP_{n,t})^{β}^{_{2+n,t}} (5)

where:
Sₖ is sales volume for day t at site i currently being estimated and for fuel type k currently being estimated (indices i and k are omitted in (5) for clarity);
OPₜ is own price per litre of fuel type k at site i;
CP_{j,t} is price per litre of fuel type k at competitor site j, for 1≦j≦n;
β_{1,t} is the intercept term; and
β_{2,t}, . . . , β_{2+n,t} are coefficients that model the effect of each variable on daily sales, referred to herein as elasticities.

In some embodiments the term β_{1,t} may have the general form β_{1,t}+D₁β_{D1,t}+ . . . +D₇β_{D7,t} where D₁, . . . , D₇ are terms associated with days of the week such that the demand model takes into account the effect of the current day of the week on sales.

The demand model (5) can be processed together with historical own price, competitor price and sales volume training data using dynamic linear modelling to generate forecasts of fuel sales at a retail fuel site for a time period, as will now be described with reference to FIG. 4.

At step S1 of FIG. 4 own fuel price data for a retail fuel site is received. The retail fuel site is a retail fuel site for which it is desirable to predict fuel sales. At step S2 competitor retail fuel price data is received. The competitor retail fuel price data is fuel price data for retail fuel sites that are competitors of the retail fuel site for which fuel price data is received at step S1. At step S3 a model is received. The model is a dynamic linear model having a plurality of parameters at time t, θₜ={β_{1,t}, β_{2,t}, . . . , β_{p,t}} where p is the number of parameters β_{1,t} of the model, and is generated based upon the demand model (5), as described in detail below. At step S4 fuel sales data that provides a forecast of sales and/or profit at the retail fuel site for which it is desirable to predict fuel sales is generated based upon the model received at step S3 and the fuel price data received at steps S1 and S2. At step S5 the parameters θₜ of the model are updated based upon the data received at steps S1 and S2, as described in detail below with reference to FIG. 6.

As indicated above, the model received at step S3 is a dynamic linear model and is specified by a Normal prior distribution for a p dimensional state vector at time t=0 with mean m₀ and variance matrix C₀, θ₀˜N₂₊ₙ(m₀,C₀), together with a general observation equation of the form (6):

log(Sₜ)=β_{1,t}+β_{2,t} log(OPₜ)+β_{3,t} log(CP_{1,t})+ . . . +β_{n+2,t} log(CP_{n,t})+vₜ (6)

where:
t is the current time; and
vₜ is a normally distributed error term with mean zero and variance Vₜ such that vₜ˜N(0,Vₜ).

The observation equation can therefore be seen to be the exponential of the demand model (5) with an additional error term vₜ.

The model additionally comprises a state equation for each parameter β_{j,t}, jε{1 . . . n+2}. The state equation for parameter β_{1,t} has the form (7):

β_{1,t}=β_{1,j-1}+wₜ (7)

where wₜ is a normally distributed error term with mean zero and variance W such that wₜ˜Nₚ(0,Wₜ) and the state equation for each parameter β_{j,t}, jε{2, . . . , n+2} has the form (8).

β_{j,t}=β_{j,t-1} (8)

The sequence (vₜ)_{t≧1} and sequence (wₜ)_{t≧1} are independent sequences of independent Gaussian random vectors with mean zero and known variance matrices (Vₜ)_{t≧1} and (Wₜ)_{t≧1} respectively.

The model is trained using a set of training data that provides historical data associated with the site for which the model is to be used. The model training iteratively generates values for each parameter of the model based upon the training data. Training of the model will now be described with reference to FIG. 5.

At step S10 data representing the model is received and at step S11 training data is received. At step S12 mean and variance values are received for each parameter β_{j,t}, jε{1 . . . n+2}. The mean and variance values received at step S12 are based upon prior knowledge of the system and may be generated in any convenient way, for example based upon previous modelling using any convenient modelling technique, or for example estimated based upon expert knowledge of the relationships between the retail fuel site and its competitors.

At step S13 variance matrices Vₜ and Wₜ are generated based upon the training data received at step S11. The variance matrices represent the volatility in the data set and are generated using Maximum Likelihood Estimation by minimising the log-likelihood, l, for the data set, where l is given by (9):

$$l = - \frac{1}{2} {\sum }_{t = 1}^{n} log \vert {Q}_{t} \vert - \frac{1}{2} {\sum }_{t = 1}^{n} {( {y}_{t} - {f}_{t} )}^{′} {Q}_{t}^{- 1} ( {y}_{t} - {f}_{t} ) \qquad ( 9 )$$

where:
yₜ is the value log(Sₜ) provided by evaluating (6) at time t;
fₜ=Fₜaₜ, where Fₜ=[1 log(OPₜ) log(CP_{1,t}) . . . log(CP_{n,t})] and aₜ=Gₜmₜ₋₁, where Gₜ is the identity matrix and mₜ₋₁ is the mean of the data at time t−1; and
Qₜ=FₜRₜF′ₜ+Vₜ, where Fₜ is as above, Rₜ=GₜCₜ₋₁G′ₜ+Wₜ, Cₜ₋₁ is the variance matrix for the normal distribution of θₜ₋₁.

At step S14 a counter i is initialised to a value 1 and at step S15 sales are forecast for time t=i using the model (5). At step S16 an updated value for each parameter is determined based upon the observed data for time i. Determination of an updated value for each parameter is described below with reference to FIG. 6. At step S17 it is determined whether there is more data to be processed. If it is determined that there is more data to be processed then processing passes to step S18 where the counter i is incremented, otherwise processing passes to step S19 where processing ends and the model parameters β_{i,j} are output to provide initial values of the model used in the processing of FIG. 4 to generate fuel sales data, which can in turn be used in an optimisation process to generate optimised fuel prices.

It has been described above that the parameters of the model are updated at step S5 of FIG. 4 and at step S16 of FIG. 5. Both the model training of FIG. 5 and the use of the model update the parameters of the model in a step wise process based upon the data received at the previous step. Processing to update the parameters to determine parameters θₜ at time t will now be described with reference to FIG. 6.

At step S20 parameter values for time t−1, θₜ₋₁, are received and at step S21 updated values for the parameters θₜ are generated. The updated values for the parameters are generated based upon the difference between the mean parameter estimate mₜ₋₁ and the mean parameter estimate mₜ, where mₜ is generated according to (10):

mₜ=aₜ+RₜF′ₜQₜ⁻¹eₜ (10)

where:
aₜ, Rₜ, Fₜ, Qₜ are as described above with reference to (9); and
eₜ=Yₜ−fₜ is the forecast error indicating the difference between predicted sales fₜ and actual sales Yₜ.

The mean parameter estimate mₜ is a vector in which each vector element provides the updated value of a corresponding one of the updated parameters. As can be seen from (10) and the parameters aₜ, Rₜ, Fₜ, Qₜ described above with reference to (9), the mean parameter estimate is generated by updating previous parameter values, mₜ₋₁, based upon error in forecasting at a subsequent time, with the effect of the forecast error being based upon volatility in the previous data set.

At step S22 the updated values for the parameters are processed to determine whether the updated value for each parameter is within a predetermined bound for the parameter. As described above, the parameters are price elasticities indicating the effect of price changes of either the site for which sales are to be forecast or of competitor sites of the own site. It will be appreciated that price increases at the site for which sales are to be forecast should have a negative impact on sales, whereas price increases at competitor sites will have a positive impact on sales. The own price elasticity, β_{2,t}, which indicates the effect of a price change for the site for which prices are to be estimated, therefore should have a negative value and the competitor price elasticities, β_{j,t,}, jε{3, . . . , p}, should each have a positive value such that the effect of a competitor price increase results in an increase in sales. However the modelling performs an optimisation that optimises a number of parameters simultaneously and such optimisation may cause parameters to be updated with incorrect sign, that is β_{2,t} may be updated to be positive and one or more of β_{j,t}, jε{3, . . . , p} may be updated to be negative. That is, the optimisation process may attribute changes in sales to a price change incorrectly.

If it is determined at step S22 that one or more parameters do not have the correct sign then at step S23 the parameters are corrected. The parameter correction modifies competitor elasticities β_{j,t}, jε{3, . . . , p} for which the value provided at step S21 is negative by setting the parameter to a value zero and adjusting the own price elasticity β_{2,t} to compensate for the correction. For example, the own price elasticity may be adjusted by adding the negative value of a negative parameter β_{j,t} to the own price elasticity β_{2,t}. Similarly, if the own price elasticity β_{2,t} is determined to have a positive value at step S2 β_{2,t} is set to a value zero and the intercept β_{1,t} is adjusted to compensate for the correction. For example, the value determined at step S21 for β_{2,t} may be multiplied by log(OPₜ) and added to the intercept β_{1,t}. In this way values that are generated at step S21 that do not satisfy the assumption that price increases at the site for which sales are to be forecast have a negative impact on sales, whereas price increases at competitor sites have a positive impact on sales are corrected.

If the parameters are determined to have the correct sign at step S22 or after the parameter modification of step S23 processing passes to step S24 where a check is performed to determine whether each parameter falls within bounds −b<β_{2,t}<0 and +b>β_{2,t}>0 for jε{3, . . . , p} where b is a pre-defined bound on the value of the elasticities. If it is determined that the parameters are outside of the bounds then at step S25 the parameters are modified in a similar manner to the modification of step S23. In particular, if an elasticity β_{j,t} has a value q>+b the value β_{j,t} is set to a value +b and a the own price elasticity is adjusted to compensate for the correction. For example, the negative difference between the original value and +b, b−q, may be added to the own price elasticity β_{2,t}. If the own price elasticity has a value q<−b, β_{2,t} is set to a value −b and the intercept is adjusted to compensate for the correction. For example, the positive difference between the original value and −b, −b−q, may be multiplied by log(OPₜ) and added to the intercept β_{1,t}.

If it is determined at step S24 that the parameters are within the bounds or after the parameter modification of step S25 processing passes to step S26. During the model use of step S5 of FIG. 4 an additional check is carried out on the parameters generated at step S21 to ensure that prices do not change significantly from one time period to a subsequent time period. As such, if it is determined at step S26 that the parameter update is during use of the model and if the parameter update is during model use at step S27 it is determined whether the difference between each parameter at time t and the corresponding parameter at time t−1 is within a predetermined bound. If it is determined at step S27 that the difference between parameter values at consecutive times is outside of the predetermined bound then at step S28 the parameters are again modified in a similar manner to the modifications of steps S23 and S25 by moving parameter changes outside of the bounds to the own price elasticity or to the intercept. It will of course be appreciated that in some embodiments separate processing may be provided for training and for model use such that no check is required at step S26.

When all required modifications to the parameters have been carried out the parameters are output at step S29.

It is described above that parameters of a model are updated as data is processed. In some embodiments parameters used to update the parameters of the model are updated after a predetermined number of data points are processed. In particular, in some embodiments the variance matrices Vₜ and Wₜ, which indicate the variation in the model and are used in the updating of the model parameters based upon both training data points and based upon use of the model, are updated after a predetermined number of data points are processed. For example, during use of the model for generation in the generation of sales data the variance matrices Vₜ and Wₜ may be updated after every 60 days of data points are received and processed. In this way the variance matrices indicate the variance of the most recently received data.

The modelling described above uses competitor prices. The competitor prices are typically received based upon a survey that is carried out at regular time intervals, for example every day at a particular time, such that the competitor prices are received for a time period and the modelling generates fuel price data based upon the competitor prices for the time period. Once the next competitor prices are received for the next time period the modelling is repeated. Methods for predicting competitor price changes will now be described.

Referring to FIG. 6, processing to generate a predicted price for a competitor site j, jε{1, . . . , n} at a time t is shown. At step S30 a trained model for the competitor site j is received. The model is a Support Vector Regression model and has the form (11):

y′=Σᵢ₌₁^{l}(αᵢ⁺−αᵢ⁻)φ(xᵢ)·φ(x′)+b (11)

where:
y′ is estimated price for the competitor site j at a time specified in input vector x′ for a prediction;
l is the number of data points i in the training data;

xᵢ is a D dimensional vector providing D input attributes associated with the site j at current time i;
φ(xᵢ) is a linear transform of xᵢ such that xᵢ→φ(xᵢ) causes yᵢ=w·φ(xᵢ)+b and is mapped using a Radial Basis Function by a kernel φ(xᵢ)·φ(x′)=exp(−γ∥xᵢ−x′∥²);
b is a predetermined value determined according to (12) below; and
αᵢ⁺, αᵢ⁻ are Lagrangian multipliers determined based upon a training set of data by maximising (11), as described below.

At step S31 input data x′ for the current time to be predicted is received. The input data x′ comprises a value for each of a plurality of variables associated with the site j and includes a value indicating a current weekday (for example a value 1 indicating Monday, a value 2 indicting Tuesday etc.), a value indicating time for which a prediction is to be made, a value indicating a current cost difference between the subsequent competitor price and the current fuel cost, a value indicating change in cost since the last competitor price change, a value indicating current own price difference between the previous competitor price and the current own price, a value indicating a change in own price since the last competitor price change and a time since the last competitor price change. Each of the input data is therefore data that is known either based upon information that is available, for example own price and cost, or that is known because it relates to historical data from a previous pricing survey.

At step S32 the model is processed together with the received input data to generate a fuel price prediction for the competitor site j at time t.

The fuel price prediction for the competitor site j at time t may be further processed to determine whether the fuel price prediction satisfies predetermined bounds on the value. For example, the fuel price prediction may be processed to determine whether the prediction falls within the range of price changes in a training set of data. For example, the training set of data used to generate the model described below may be processed to determine a largest positive change and a largest negative change between consecutive time points and the fuel price prediction may be modified if it is determined to be greater than either of the largest changes. Additionally or alternatively the training set of data may be processed to determine a largest positive and a largest negative change over a predetermined time period for which predictions are to be made, for example over a 24 hour period, and price estimates for a competitor retail fuel site may be limited to the determined values for the 24 hour period.

The model (10) is trained using a training set of data to determine Lagrangian multipliers αᵢ⁺, αᵢ⁻. The values αᵢ⁺, αᵢ⁻ are determined by maximising (12) below with respect to αᵢ⁺ and αᵢ⁻ using a Quadratic Programming method, as is known in the art.

$$L = - \frac{1}{2} {\sum }_{i , j} ( {α}_{i}^{+} - {α}_{i}^{-} ) ( {α}_{j}^{+} - {α}_{j}^{-} ) φ ( {x}_{i} ) φ ( {x}_{j} ) + {\sum }_{i = 1}^{L} ( {α}_{i}^{+} - {α}_{i}^{-} ) {y}_{i}^{*} - ɛ {\sum }_{i = 1}^{L} ( {α}_{i}^{+} + {α}_{i}^{-} ) \qquad ( 12 )$$

where:
for all i, αᵢ⁺ε(0,C), αᵢ⁻ε(0,C) where C is a predetermined cost, and

$${\sum }_{i = 1}^{L} ( {α}_{i}^{+} - {α}_{i}^{-} ) = 0 ;$$

φ(xᵢ), φ(xⱼ) are linear transformations of the data at training points i, j respectively;
yᵢ* is the observed price at training point i; and
ε is a predetermined error tolerance for which if |yᵢ*−yᵢ|>ε then the estimated value yᵢ is given one of two slack variable penalties, with a penalty ξ⁺ applied if the actual value yᵢ* is greater than yᵢ+ε and a penalty ξ⁻ if the actual value yᵢ* is less than yᵢ−ε.

As indicated above, the value b of (11) is a predetermined value and is determined based upon the Karush-Kuhn-Tucker (KTT) conditions described in H. W. Kuhn, A. W. Tucker, “Nonlinear Programming”, Proceedings of 2^{nd} Berkeley Symposium on Mathematical Statistics and Probability, pp. 481-492, 1951, which is herein incorporated by reference. In particular, according to the KTT conditions, an average value b across each training point i of the training data is determined according to (13) below.

b=yᵢ*−w·φ(x)−ε for αᵢ⁺ε(0,C)

b=yᵢ*−w·φ(x)+ε for αᵢ⁻ε(0,C) (13)

The value b can be determined by substituting w for (14):

$$w = {\sum }_{i = 1}^{l} ( {α}_{i}^{+} - {α}_{i}^{-} ) φ ( {x}_{i} ) \qquad ( 14 )$$

and using the known kernel φ(xᵢ)·φ(x′)=exp(−γ∥xᵢ−x′∥²).

The competitor price change prediction described above allows competitor price changes to be predicted during the time period and fuel price data to be generated based upon the predicted competitor price changes. For example, it may be known from historical data that a competitor typically changes their price at predetermined time points during a day. By inputting vectors x′ specifying the known times that a competitor typically changes prices during a day the model of (11) can be used to predict the competitor price changes at the known times and the predicted competitor price changes can be used to make pricing decisions.

As noted above, during a time period t such as a day price changes to both own price and competitor price may be made, with changes to own price possibly affecting future changes to competitor price and vice versa, the effects of which may be predicted using the competitor price prediction described above. Methods for determining fuel price data taking into account future effects of pricing will now be described with reference to FIG. 7.

At step S40 current pricing data is received. The current pricing data comprises a current own price and current competitor price data. At step S41 pricing constraints are received. The pricing constraints specify constraints on own price relative to one or more competitor prices. At step S442 competitor pricing time data is received. The competitor pricing time data provides one or more times during the time period t at which competitor prices change. For example the competitor pricing time data may comprise times at which a survey of competitor prices is performed to provide updated competitor prices.

At step S43 a counter i is initialised to a value 1. The counter i is arranged to count through iterations of the processing of steps S44 to S47 for each time of the time data in time period t. At step S44 a competitor price estimate for time i is received. The competitor price estimate may for example be generated using Support Vector Regression as described above. At step S45 possible own price values are generated for time i based upon the competitor price estimate received at step S44 and the pricing constraints received at step S41. For example, typically the price constraints provide variation of price relative to competitor price that is permitted and a the processing of step S45 generates each permitted price within the variation indicated by the price constraints.

At step S46 it is determined whether more times within time period t remain to be processed and if more times remain then at step S47 the counter i is incremented and the processing of steps S44 to S46 is repeated, with new possible price values being generated for each time i+1 based upon each possible price value generated at the subsequent time i. The processing of steps S44 to S46 therefore can be seen to generate a plurality of possible paths, with each path representing a sequence of possible price changes and each price change being dependent upon each previous price in the sequence.

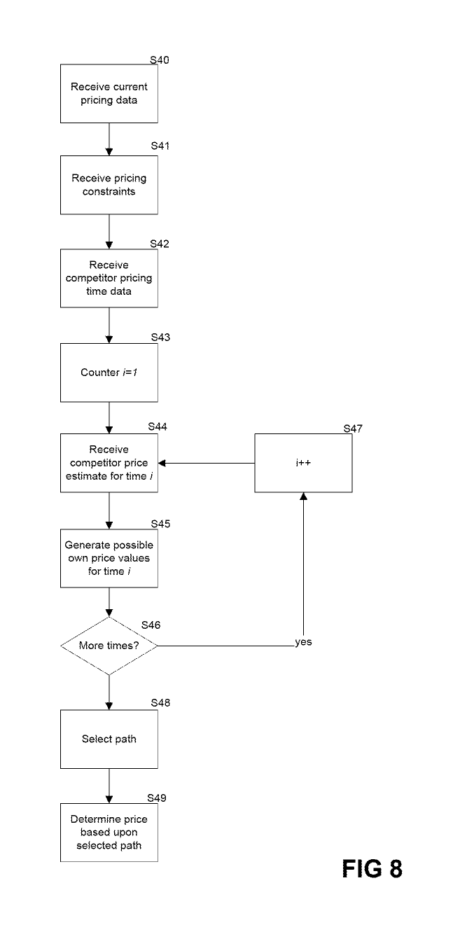

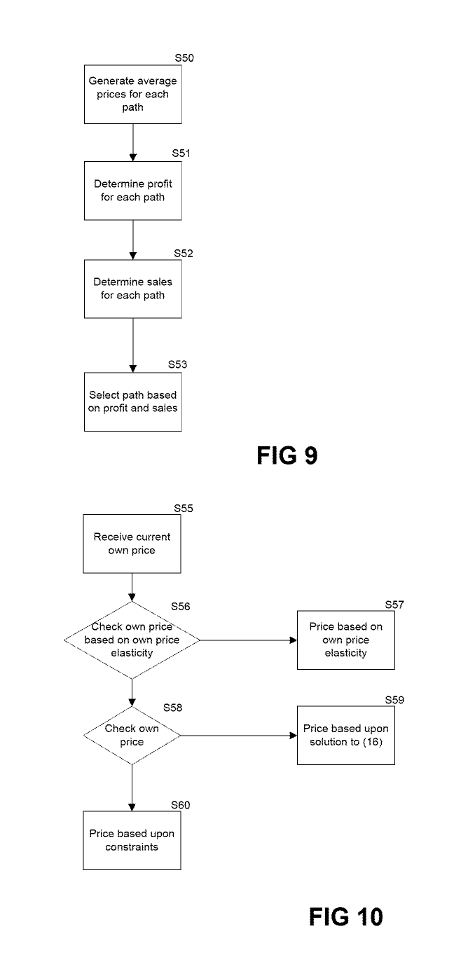

If it is determined at step S46 that each time in time period t has been processed then at step S48 one of the paths is selected, for example using the processing of FIG. 8 described below. At step S49 pricing data is generated based upon the selected path. In particular, own price is set based upon the value of own price for time i=1 in the selected path.

When competitor pricing data is received for time i=1, if the observed competitor price corresponds to the estimated price for time i=1 then own price can be set to the value indicated at time i=2 in the path selected at step S48 as the path selected at step S48 remains the optimal path and therefore still provides optimal pricing. However if the observed competitor price is different to the estimated competitor price for time i=1, the processing of FIG. 7 is repeated to generate new paths based upon the observed competitor price.

Referring to FIG. 8, processing to select a path at step S48 of FIG. 7 is shown. At step S50 average own and competitor prices for the time period are generated for each path based upon the sequence of own and competitor prices in the path. At step S51 a profit is determined for each path based upon the modelling described above and at step S52 a total sales is determined for each path based upon the modelling. At step S53 an optimal path from the plurality of paths is selected based upon the profit and sales determined at steps S51 and S52. In particular, the optimal path is selected such that the path provides a maximal profit whilst simultaneously satisfying any predetermined sales target that may be set for the own site.

In some embodiments it may not be possible to forecast competitor price, however it is still desirable to optimise profit at an own site whilst considering possible competitor site price changes. However in such embodiments it is possible to optimise fuel pricing taking into account future effects of pricing of a competitor. In particular, it is possible to optimise pricing based upon the worst case competitor price change following an own price change, which can be shown to be a competitor ignoring an own price increase, such that sales are reduced as customers buy fuel from the cheaper competitor, but following own price decreases. Pricing to optimise fuel prices taking into account worst case competitor price changes will now be described with reference to FIG. 10.

At step S55 current own price is received and at step S56 a check is carried out to determine whether current own price is less than a minimum threshold value based upon minimum wholesale cost value, weighted by the own price elasticity. For example the check of step S56 may be based upon (15).

$$\frac{{β}_{2 , t} * {C}_{t}}{{β}_{2 , t} + 1} \qquad ( 15 )$$

where:
β_{2,t} is own site price elasticity at time t; and
Cₜ is wholesale cost at time t.

If it is determined that own price is less than the minimum threshold value then at step S57 current own price is increased to be as close to the minimum threshold value as the own site pricing constraints allow. It can be shown that where own price is less than the minimum threshold value pricing to be as close to the minimum threshold value as possible provides optimal pricing even if the competitor does not follow own price.

If current own price is greater than the minimum threshold value then at step S58 a check is carried out to determine whether own price is greater than a maximum threshold value, the maximum threshold value being weighted by own and competitor price elasticities taking into account the difference between competitor price and own price per unit time in time period t. For example, the maximum threshold value may be provided by the solution to (16):

$$\frac{1}{{OP}_{t} - {C}_{t}} + \frac{{β}_{2 , t}}{{OP}_{t}} + \frac{{β}_{3 , t}}{{OP}_{t} + Δ} = 0 \qquad ( 16 )$$

where:
β_{2,t} is own price elasticity;
β_{3,t} is competitor price elasticity; and
Δ is the difference between competitor price and own price per unit time in time period t.

If it is determined that own price is greater than the maximum threshold value then at step S59 own price is set as close as the constraints allow to the maximum threshold value. Otherwise at step S60 own price is set as the price closest to the minimum threshold value or the maximum threshold value that satisfies the pricing constraints. By setting price in this way then profit can be optimised in competitor price uncertainty based upon a worst case competitor price reaction to a pricing change.

The processing of FIG. 10 can be extended to model more than one competitor by including the further competitors in (16).

Although specific embodiments of the invention have been described above, it will be appreciated that various modifications can be made to the described embodiments without departing from the spirit and scope of the present invention. That is, the described embodiments are to be considered in all respects exemplary and non-limiting. In particular, where a particular form has been described for particular processing, it will be appreciated that such processing may be carried out in any suitable form arranged to provide suitable output data.

1-41. (canceled)

42. A computer-implemented method of generating fuel price data for a retail fuel site, the method being implemented in a computer comprising a memory in communication with a processor, the method comprising:
receiving, as input to the processor, relationship data indicating a relationship between the retail fuel site and a competitor retail fuel site;
receiving, as input to the processor, fuel price data for the competitor retail fuel site;
processing, by the processor the fuel price data for the competitor retail fuel site to generate estimated fuel price data for the competitor retail fuel site; and
generating, by the processor, said fuel price data for the retail fuel site based upon the relationship data and the estimated fuel price data.

43. The method of claim 42, wherein said estimated fuel price data for the competitor retail fuel site is a prediction of fuel price for the competitor retail fuel site at a time in the future.

44. The method of claim 42, wherein said estimated fuel price data for the competitor retail fuel site is an estimate of historical fuel price for the competitor retail fuel site that is unavailable.

45. The method of claim 42, wherein said fuel price data for the competitor retail fuel site comprises a value for each of a plurality of variables associated with the competitor retail fuel site.

46. The method of claim 45, wherein said plurality of variables associated with the competitor retail fuel site comprises at least one value selected from the group consisting of: a value indicating a current weekday; a value indicating a time for which a prediction is to be made; a value indicating a current cost difference between a fuel price at the competitor retail fuel site at first and second times; a value indicating a difference between fuel price at the retail fuel site at a first time and fuel price at the competitor retail fuel site at a second time; a value indicating a change in fuel price at the retail fuel site since a previous a change in fuel price at the competitor retail fuel site; and a time since a most recent competitor price change.

47. The method of claim 42, wherein processing the fuel price data for the competitor retail fuel site to generate estimated fuel price data for the competitor retail fuel site comprises:
receiving, as input to the processor, a model; and
processing, by the processor, the fuel price data for the competitor retail fuel site based upon the received model.

48. The method of claim 47, wherein said model is a support vector regression model.

49. The method of claim 47, further comprising generating said model, said generating comprising:
receiving, as input to the processor, a training set of data, said training set of data providing fuel price data for the competitor retail fuel site at a plurality of times; and
processing, by the processor, the training set of data using a quadratic programming method to determine at least one Lagrangian multiplier.

50. The method of claim 49, wherein said training of set of data comprises an observed price for the competitor retail fuel site at each of said plurality of times, and wherein processing the training set of data to determine at least one Lagrangian multiplier comprises, for each of said plurality of times:
determining, by the processor, an estimated price for the competitor site for said plurality of times;
determining, by the processor, whether a difference between said estimated price and said observed price exceeds a predetermined value; and
if said difference exceeds a predetermined value, assigning, by the processor, a penalty to said data for said time.

51. The method of claim 47, wherein said model comprises an average value.

52. The method of claim 47, wherein said average value is generated based upon a training set of data providing fuel price data for the competitor retail fuel site at a plurality of times.

53. The method of claim 42, further comprising:
receiving at least one bound associated with the competitor retail fuel site; and
generating said estimated fuel price data for the competitor retail fuel site based upon the at least one bound.

54. The method of claim 53, wherein said at least one bound is associated with a maximum change of fuel price data at the competitor retail fuel site.

55. An intangible computer readable medium carrying a computer program comprising computer readable instructions configured to cause a computer to carry out a method comprising:
receiving, as input to the processor, relationship data indicating a relationship between the retail fuel site and a competitor retail fuel site;
receiving, as input to the processor, fuel price data for the competitor retail fuel site;
processing, by the processor the fuel price data for the competitor retail fuel site to generate estimated fuel price data for the competitor retail fuel site; and
generating, by the processor, said fuel price data for the retail fuel site based upon the relationship data and the estimated fuel price data.

56. A computer apparatus for generating fuel price data for a retail fuel site, the apparatus comprising:
a memory storing processor readable instructions; and
a processor arranged to read and execute instructions stored in said memory;
wherein said processor readable instructions comprise instructions arranged to control the computer to carry out a method comprising:
receiving, as input to the processor, relationship data indicating a relationship between the retail fuel site and a competitor retail fuel site;
receiving, as input to the processor, fuel price data for the competitor retail fuel site;
processing, by the processor the fuel price data for the competitor retail fuel site to generate estimated fuel price data for the competitor retail fuel site; and
generating, by the processor, said fuel price data for the retail fuel site based upon the relationship data and the estimated fuel price data.
